(19) United States
(12) Patent Application Publication
(10) Pub. No.: US 2019/0183089 A1
(43) Pub. Date: Jun. 20, 2019

(54) DEVICE AND METHOD OF ANIMAL HUSBANDRY EQUIPMENT

(71) Applicant: Vium Inc, San Mateo, CA (US)

(72) Inventors: Kevin Harada, San Francisco, CA (US); Larry Stevens, San Jose, CA (US); Laura Schaevitz, Los Gatos, CA (US)

(73) Assignee: Vium Inc., San Mateo, CA (US)

(21) Appl. No.: 15/849,239

(22) Filed: Dec. 20, 2017

(51) Int. Cl. A01K 1/03; A01K 15/02

(52) U.S. Cl. CPC A01K 1/03; A01K 5/0114; A01K 15/027

(57) ABSTRACT

A device, system and method of equipment sets, “furniture,” to provide animal husbandry functions are described. Embodiments include: a frame in the form of a ring adapted to sit in a single possible orientation within an animal cage, wherein the frame comprises hollow, open-top vertical columns, adapted to receive pieces of furniture comprising mating pins; a running wheel mounted on a axle integral to the monolithic frame; a horizontal climbing ladder; and a food tray. Embodiments include feet extending from the frame for fixed positioning within a cage; a reserved area to hold a weight scale; curved corners for cage fit; monolithic construction of all individual elements; a canted wheel axis; a sloped inner edge of a food tray to permit unobstructed views of animals in a cage. Methods include assembly; use in an animal cage; and use to observe and measure animal activity using husbandry-only procedures for the animals; and for animal studies using non-invasive procedures.

### BACKGROUND OF THE INVENTION

This invention relates to equipment in an animal cage to provide animal husbandry functions. Such in-cage animal husbandry equipment may be called, “animal furniture,” “cage furniture,” or just, “furniture.” It may be used to as part of a system and method to record animal behavior using automated methods and sensors.

Prior art uses individual pieces of equipment, such as a food tray or exercise wheel. Such pieces of furniture are often moved about a cage by the animals. If a camera or other automatic sensor is used to observe animal behavior in a cage, variable locations of furniture present problems such as obscuring views or blocking operation of the furniture. In addition, in a study it is desirable that all cage in the study are equipped as similarly as possible. Freely moved furniture creates inconsistent cage environment.

Prior art equipment is often too expensive to use as disposable cage elements, and may also be difficult or expensive to sterilize.

### SUMMARY OF THE INVENTION

Embodiments of this invention overcome limitations in prior art.

Descriptions and scenarios are non-limiting examples.

The term, “animal furniture,” or “furniture,” is equivalent to “animal husbandry equipment,” unless otherwise clear from the context. A “set” of animal husbandry equipment is two or more pieces of furniture, which may or may not be physically and functionally independent. Such furniture typically provides an appropriate and—per best practices in the art—required function in the animal cage, ideally a home cage of one or more animals.

There are multiple reasons to keep animal furniture at fixed, known, and consistent positions in all cages in an animal study, such as in a vivarium. First, since animals tend to push their furniture around, and may clog it with bedding, fixed positions maintain proper function of furniture, including access to food, a freely rotating exercise wheel, or an unclogged scale, as examples. Second, in a vivarium or for a cage with automated observation, such as the use of a video camera, a wireless weight scale, or an animal ID detecting sensor, specific locations of furniture may be needed for proper functioning of such electronics or sensors. For example, a camera may need a clear view of a cage floor. Third, for multiple cages in a study, it is critical that the cages, animals, and equipment in the cages be as uniform as possible. For example, if one cage has a functioning exercise wheel and another cage does not, they do not provide equivalent environments, which compromises study quality.

One embodiment uses a monolithic frame that rests on the floor of a cage, where the frame has vertical supports designed to easily mate to furniture elements without the use of tools. The frame also has extensions, “feet,” so that it fits into a cage in only one orientation and so that it cannot be move more than a minor distance for clearance and mechanical tolerance. Pieces of furniture may include an exercise wheel, a climbing ladder, and a food tray. Other embodiments include a water bottle and a dedicated location or mount that holds a weight scale. Other furniture elements may be used and the frame may or may not comprise dedicated mating features.

Embodiments configure the frame in the shape of a non-uniform, generally rectangular ring, with hollow columns affixed on the frame, wherein the hollow columns are sized and spaced to permit tool-less mating of furniture elements with corresponding downward facing pins the drop into the open-top columns.

Embodiments include a triangular wheel support rising from the frame, where the wheel support includes or is adapted to mate with a nominal horizontal axle for a wheel. The axle may be tilted at up to 20 degrees from horizontal.

Embodiments include a monolithic frame that may also include the columns and wheel supports as part of the single monolithic structure.

In some embodiments, the frame rests directly on the floor of a cage, or on top of bedding. The frame “feet” may extend horizontal from the frame towards the cage walls, and may also extend upward at an angle from the frame.

Benefits include low cost so the all furniture elements may be disposable after a single use in a cage for a study in a vivarium. Benefits also include easy assembly and disassembly, free of tools. Benefits also include consistent locations within a cage for furniture, both as initially placed by a worker and also so they stay in their original locations, rather than be pushed around by animals in the cage. Additional benefits are discussed above. Benefits of manufacturing furniture from clear plastic are that light is distributed throughout a cage, with minimal shadows and dark areas.

### BRIEF DESCRIPTION OF THE DRAWINGS

FIG. 1 shows an assembled embodiment with a frame, wheel, ladder and food tray.

FIG. 2 shows an exemplary food tray.

FIG. 3 shows an exemplary climbing ladder.

FIG. 4 shows an exemplary running wheel.

FIG. 5 shows an exemplary stand-alone frame.

### DETAILED DESCRIPTION

Descriptions, embodiments, scenarios, examples, and Figures are non-limiting

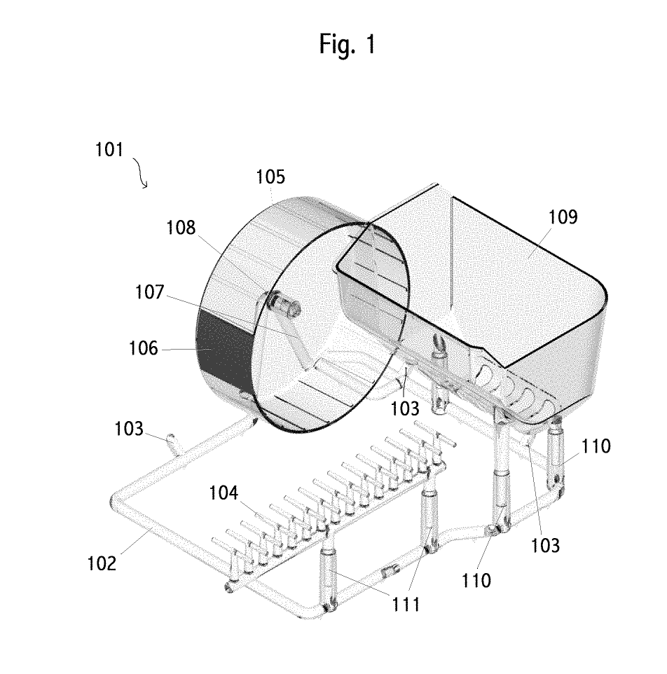

Turning now to FIG. 1, we see an exemplary assembled configuration of animal cage furniture 101, including a frame 102, three alignment feet 103, a climbing ladder 104, a running wheel 105 with a visible, black patch 106 useful for counting wheel rotations using a vision system (not shown), wheel supports 107, a wheel axle, axis or axle support 108 for the wheel 105, a food tray 109, supports 110 for the food tray 109 (two of three supports shown designated 110), and two ladder supports 111. Proportions, dimensions and locations of elements may differ substantially from those shown. Elements shown may be clear or translucent, with the exception of black patch 106 on the wheel, which should show visible contrast compared to the rest of the wheel periphery, whether the wheel is opaque, translucent or transparent. The food tray 109 may be opaque. The wheel 105 may have a tilted axis or axle 108.

Ideally, elements such as the climbing ladder 104 and food tray 109 are easily assembled on the frame 102 by simply aligning their downward facing pins into the upward facing, hollow, open support columns, such as 110 and 111. The wheel 105 may be slipped over its support and axle 108. Elements are held in place by gravity or a formed bump, clip or other device, ideally part of the monolithic structures. Column supports may vary in number. Shown are two 111 for the climbing ladder 104, three 110 for the food tray 109, and a triangular support 107 for the wheel 105.

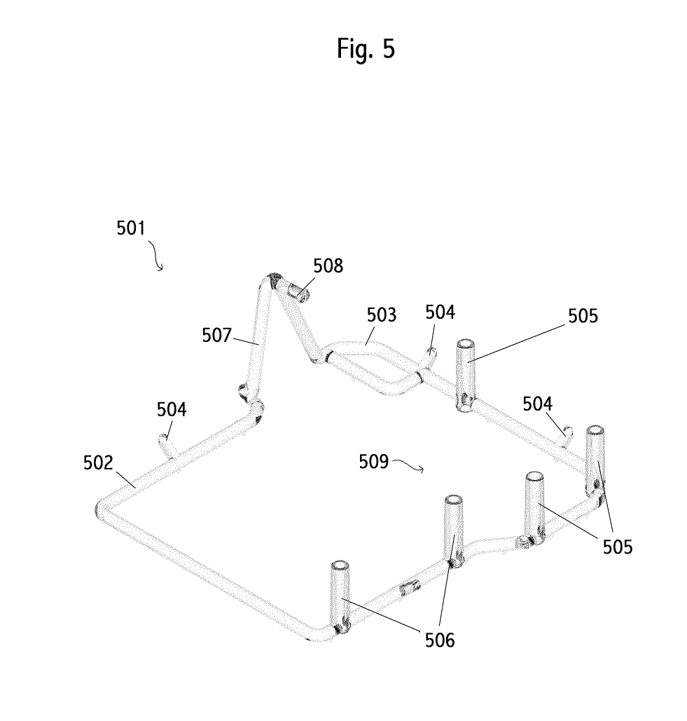

In some embodiments the frame 102 fits into the interior floor of an animal cage in only one orientation and fits so that horizontal motion in the cage is limited, such as in the range of 0.1 mm to 50 mm, or the range 1 mm to 10 mm. Motion of the frame is restrained, in one embodiment by feet 103 extending outward and upward from the frame 102. Corner shapes of the frame may also be used to fit within a cage. See also FIG. 5. The frame 102 may provide a reserved location for a weight scale (not shown), including optional mating elements. See FIG. 5. Elements frame 102, wheel 105, ladder 104 and food tray 109 are ideally monolithic. Construction material may vary widely, but should be non-toxic to animals, inexpensive, and provide no corners, edges or projections that might injure or be chewed by an animal. PET plastic is one such material.

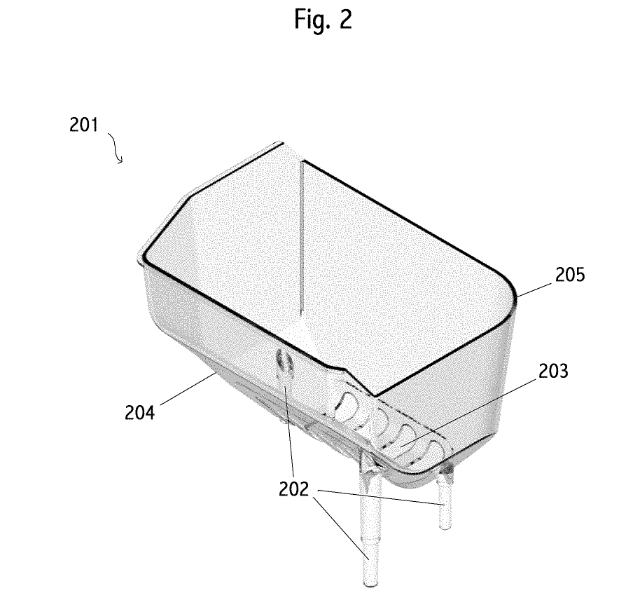

In one embodiment a portion of the food tray 109 facing toward the center of the cage is sloped so as to minimize cage area in which an animal may be partially or fully out of sight of an overhead camera (not shown). See FIG. 2.

Turning now to FIG. 2 see a standalone food tray 201. The tray has a sloped side 204 to provide optimal visibility of an animal under the food tray, such as for a camera (not shown). The tray has three feet 202, although the number of feet may vary. The feet pins drop into corresponding open vertical columns in a frame. The food tray 201 may be placed into only one position on a frame, and may be easily placed and lifted out for refilling without tools. The tray has slots on the bottom 203 sized small enough to keep food from falling through easily, but large enough for an animal to eat or pull food through. In one embodiment the tray has one or more curved edges 205 that fit to match interior curves inside a cage.

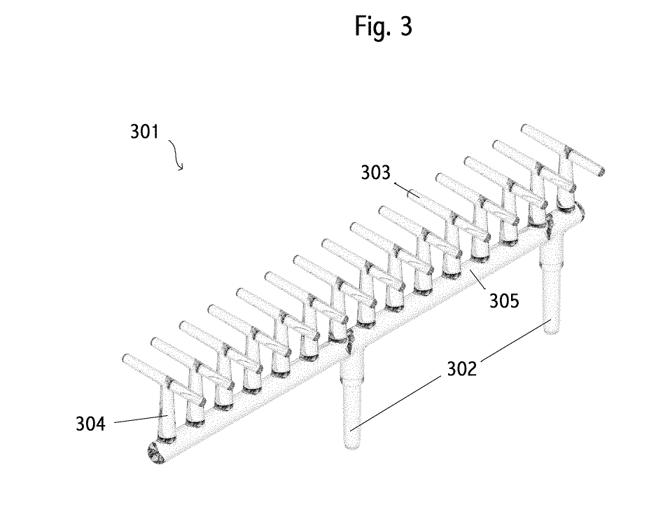

Turning now to FIG. 3 we see a horizontal climbing ladder 301 comprising horizontal rungs 303 (here, 15 rungs), each on its own vertical rung support 304, which in turn are mounted on a ladder bar 305, which in turn is supported by two (or more) feet 302. Like the food tray 109, the feet pins 302 on the ladder 301 drop into corresponding hollow columns in a frame 102. Alternative ladders may be vertical or at an angle. Ideally the diameter and spacing of the rungs 303 is sized for animals in a cage, such as mice or rats. The rungs should be small enough that the animals' toes or feet may grip them, and far enough apart so that walking on the ladder is relatively easy for a healthy animal. Such ladders not only provide exercise for an animal, but also may be used to determine health such as gait, speed, quantity of usage, slipping on the ladder, and the like. Note that this ladder 301 as shown is not fully symmetric because of the positions of the feet 302 on the bar 305. However, another embodiment is symmetric. In such an embodiment, a ladder flipped 180 degrees is still considered to be constrained to a single orientation.

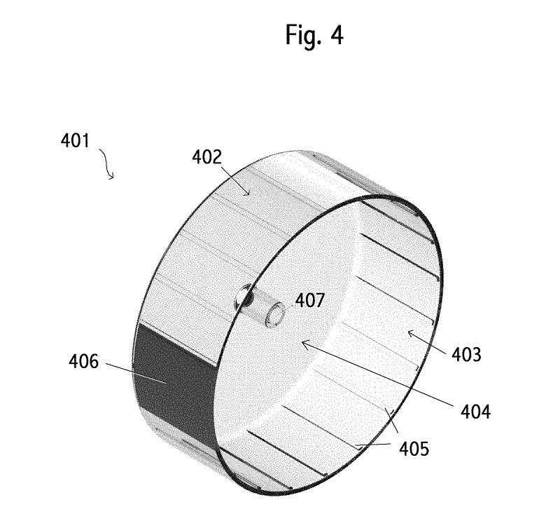

Turning now to FIG. 4, we see an exemplary exercise wheel 401. The wheel is the form of an open cylinder, defined by the continuous wheel wall 402 (outside surface) and 403 (inside surface) on the circumference and a flat surface face 404 securing the walls to an axle bearing 407. The flat surface face 404 should be free of openings large enough for an animal to place a toe, foot or nose. 402 shows an outside surface of the wheel, which includes a contrasting, opaque region 406 that may be used, via an automatic vision system to count wheel rotations, measure wheel speed, and record wheel usage by animals. The wheel axis may be tilted from horizontal in the range greater than zero degrees and less than 20 degrees. Such tilt aids in animals staying in the wheel while running and also aids in the wheel throwing out lose detritus such as bedding. 403 shows an interior surface on which an animal runs. Embodiments also include ridges 405 on the interior surface 403 that the animal may grip with its feet or toes to aid in use of the wheel. The size and spacing of the ridges 405 should be appropriate for an animal, such as a mouse or rat. Ideally, the wheel is monolithic. See elsewhere herein for materials and material attributes. Embodiments include wheels that have no supports other than on an axle through a monolithic axle bearing. Embodiments include wheels that are free to rotate, with the only motive force provided by one or more animals.

Turning now to FIG. 5 we see a standalone frame 501. The frame 501 has a generally rectangular ring form 502. It may have feet or legs 504 that extend outward and optionally upward (here, three feet), to aid in fitting the frame and mounted furniture into a cage in a single orientation. The frame may have one or more curved corners, such as 503, that mate with curves on the inside of a cage to aid in fitting the frame and mounted furniture into a cage in a single orientation. 505 shows three open, hollow support columns for a food tray. 506 shows two hollow support columns for a climbing ladder. 507 shows a triangular support for a wheel, including an axle 508 with a shown retention clip. A frame may have a reserved area for a weight scale or other equipment, Here such as area is shown as 509. Careful viewing of the shape of the frame 502 will reveal that the open area 509 will retain a properly shaped and sized scale (not shown), which may be constrained by the shape of frame 502 to a single orientation.

Although named, “feet,” the frame does not necessary rest on the feet. Although we use the terms, “feet,” or “legs,” such elements may be any extension or portion of the frame beyond which is strictly necessary for another purpose of the frame, such as supporting furniture. For example, a corner of the frame may be shaped so as to provide the described function of a foot or leg, but which otherwise is unnecessary or could be in a simpler or smaller shape. The proper construction of “feet” includes such a corner. Such feet may extend downwards, horizontally, or upwards from the remainder of the frame. A frame may be serpentine shape, with certain portions of the shape providing the explicit function of the feet.

### Other Embodiments

Other embodiments specifically claimed include embodiments where “feet” are integral to the shape of the frame, and thus do not have a trivially defined “proximal” and “distal” ends. Thus, any such limitation may be struck from a claimed embodiment. “Ladders” may be vertical, horizontal, or angled. Such ladders come in a variety of forms, as known in the art. However, they all have “rungs” of some shape that require an animal to place its feet properly, and may require some balance skill by the animal. Food trays come in a variety of forms, as know in the art. They all have some type of opening through which the animal may feed or pull food from the tray. Typically, animal cages have separate water bottles and food trays; these are easily refilled by vivarium workers. They may or may not need to be removed from the cage to refill. A lid of the cage may or may not need to be removed in order to so access a water bottle or food tray. Some embodiments use non-refillable water bottles or food trays. Embodiments are specifically claimed where “water bottle” is substituted for, or added to, “food tray.”

Animal husbandry equipment sets all include a frame element and at least one of: {food tray, exercise wheel, climbing ladder}. Supports in the frame for any combination of: {food tray, exercise wheel, climbing ladder, weight scale} are ideally adapted to attach with and release from the corresponding piece of equipment without the use of tools. Such connections may rely on gravity, a spring clamp, friction clamp, pressure fit, magnetic clamp, twist clamp, constraining shape, temporary adhesive, or other means. “Clamp” should be construed broadly to include any type of latch or restraint. Such elements may include hollow tubes, open on one end and optionally with side openings, with a corresponding pin that fits into the open end of the tube. Such elements may face either up or down. In some cases, such as to support a wheel axle or bearing, or support any other piece of equipment, may also face horizontally or at an angle. Proper construction of such mating elements include any specifically constructed shape or shapes that provide the purpose of restraining the associated piece of equipment to a specific, predetermined location relative to the frame, and optionally also a specified orientation. For example, simple horizontal stops may be used for this purpose, if properly sized and positioned. Embodiments are claimed for frame shapes that are not a “ring.” For example, a frame may be a plate, in the form of a star, or another shape. Rings need not be round. See, for example, 502. Here, “ring,” means that it encloses an area. Embodiments are claimed where the frame hangs from an upper lip of a cage, rather than resting on the floor of the cage. Embodiments are claimed where the “husbandry equipment set volume” is determined by a combination of the frame and zero or more of the elements: {food tray, exercise wheel, climbing ladder, weight scale}. Some embodiments include a constrained space for a piece of equipment, rather than mechanically mating elements. Such an embodiment is particularly appropriate for holding a weight scale, or a nesting area or nesting equipment; however constrained equipment spaces may be used for any piece of equipment. It is preferred that all such constrained spaces constrain the associated equipment to a single location and orientation. Embodiments may include adaptations for symmetric equipment, for example a climbing ladder, such that the equipment may be placed in any symmetric orientation. Where such symmetry exists, construction of, “only one orientation” includes such equivalent, symmetric orientations.

Embodiments are claimed for methods of providing animal husbandry equipment in cages and in in vivariums. Embodiments are claimed for methods of automated observation of animal activity using such equipment. Embodiments of equipment sets are particularly well suited for observing, recording and measuring animal behavior or activity, or data from sensors, in response to normal animal husbandry activities, as contrasted with prior art that uses invasive testing procedures. Embodiments are claimed for methods of animal studies using non-invasive testing.

Embodiments are specifically claimed for all and combinations of the furniture elements described; methods of assembly and disassembly of those elements onto the frame; methods of use in a vivarium cage; and methods of use with animals in the vivarium cages so equipped to automatically record animal husbandry activity on the furniture. Some embodiments of methods are free of any invasive testing. Embodiments include various combinations of furniture, vivarium cages, video cameras, animals, and vivariums, Embodiments include disposable furniture. Embodiments are specifically claimed for systems using any combination of devices and methods.

### Definitions

“Sterile air”—Means pathogen-free air, such as air interior in a cage, in the context and meaning in the operation and art of operating vivariums.

“Pathogen-free”—means the population of microbes, including but not limited to bacteria, viruses, prions and toxins, relevant to an experiment, test or study (“study”), is sufficiently reduced to meet the needs of the study, or to impact or alter study results, or to alter the credibility or repeatability of study results, for studies using the vivarium, and to not impact the health, performance or behavior of the target animal population in the vivarium or of the workers.

Ideal, Ideally, Optimum and Preferred—Use of the words, “ideal,” “ideally,” “optimum,” “optimum,” “should” and “preferred,” when used in the context of describing this invention, refer specifically a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

Embodiments of this invention explicitly include all combinations and sub-combinations of all features, elements and limitation of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substation thereof to any and all other device claims, including all combinations of elements in device claims. Claims for devices and systems may be restricted to perform only the methods of embodiments or claims.

We claim:

1. A set of animal husbandry equipment comprising:
a frame comprising:
a horizontal floor ring;
one or more centering feet each affixed at a proximal end to the floor ring;
one or more vertical food tray supports each affixed at a lower end to the floor ring;
one or more vertical ladder supports each affixed at a lower end to the floor ring;
one or more vertical wheel supports each affixed at a lower end to the floor ring, adapted to support a wheel axle;
an animal exercise wheel adapted to rotate around the wheel axle;
an animal food tray adapted to mount on the food tray supports; wherein the animal food tray comprises at least one open slot disposed at a lower portion of the animal food tray and adapted to hold animal food;
a horizontal animal exercise ladder adapted to mount on the ladder supports;
wherein the centering feet and a mounted animal food tray define a husbandry equipment set volume;
wherein the husbandry equipment set is adapted such that the husbandry equipment set volume fits inside a predetermined animal cage in only one possible orientation in the cage.

2. The set of animal husbandry equipment of claim 1 wherein:
the frame, the animal exercise wheel, the animal food tray, and the horizontal animal exercise ladder are adapted such these elements of the set may be assembled and disassembled without the use of tools.

3. The set of animal husbandry equipment of claim 1 wherein:
the animal exercise wheel comprises a wheel bearing, a circumferential solid running surface comprising a plurality of spaced ridges on the inside of the of the running surface; and an opaque, contrasting region on the outside of the running surface; wherein the animal exercise wheel is monolithic.

4. The set of animal husbandry equipment of claim 1 wherein:
the horizontal animal exercise ladder comprises a plurality of horizontal rungs, a horizontal latter bar, wherein each rung is attached to the ladder bar via a single vertical rung support; wherein the horizontal animal exercise ladder further comprises one or more vertical support pins extending downwards from the ladder bar, perpendicular to the ladder bar; wherein the axes of the horizontal rungs are perpendicular to and offset from the axis of the ladder bar; wherein the horizontal animal exercise ladder is monolithic.

5. The set of animal husbandry equipment of claim 1 wherein:
the animal food tray comprises a sloped face that angles from an upper edge towards the plurality of open slots; and further comprises at least one curved upper corner.

6. The set of animal husbandry equipment of claim 1 further comprising:
a vivarium cage, free of electrical penetrations, adapted such that an assembled set comprising the frame, the animal exercise wheel, the horizontal running ladder, and the animal food tray, fits inside the vivarium cage in exactly one orientation.

7. The set of animal husbandry equipment of claim 6 further comprising:
a video camera, outside the vivarium cage, adapted such that a video camera lens has a camera view of the bottom of the vivarium cage, and wherein the animal food tray does not obscure the camera view.

8. The set of animal husbandry equipment of claim 1 wherein:
the frame is monolithic.
